(19) United States
(12) Patent Application Publication
(10) Pub. No.: US 2015/0135613 A1
(43) Pub. Date: May 21, 2015

(54) ECO-FRIENDLY STRUCTURE CAPABLE OF REDUCING STRONG WIND PRESSURE AND STORING RAINWATER AND METHOD FOR MANUFACTURING STRUCTURE

(71) Applicant: HOLE IN ONE CO., LTD., Daejeon (KR)

(72) Inventors: Ki Young Kim, Daejeon (KR); Jong Pil Chun, Daejeon (KR)

(73) Assignee: HOLE IN ONE CO., LTD., Daejeon (KR)

(21) Appl. No.: 14/408,918

(22) PCT Filed: May 27, 2013
(86) PCT No.: PCT/KR2013/004591

§ 371 Date: Jan. 15, 2015

(30) Foreign Application Priority Data
Oct. 24, 2012 (KR) 10-2012-0118237
Apr. 5, 2013 (KR) 10-2013-0037453

(51) Int. Cl. E04B 2/30; E04B 1/48; B29C 33/38; E04H 9/14; E03B 1/04; E04B 1/04; E04C 1/39

(52) U.S. Cl. CPC E04B 2/30; E04B 1/04; E04B 1/48; E04C 1/395; E04C 1/397; E04H 9/14; E03B 1/048; B29C 33/3842; E04B 2103/02; E04B 2002/0245
USPC 52/173.1; 264/219

(57) ABSTRACT

The present invention relates to an eco-friendly structure capable of reducing strong wind pressure and a method for manufacturing the structure and, more specifically, to an eco-friendly structure capable of reducing strong wind pressure and storing rainwater and a method for manufacturing the structure, wherein: the structure is installed in order to protect various structures being used in farming and fishing villages, and fruit trees, temporary buildings or vehicles on a road, or rail and port facilities, in case of the occurrence of a typhoon or strong wind pressure; hexagonal blocks are manufactured using waste concrete (stone) and waste plastic, which are construction and industrial waste; and a plurality of the manufactured hexagonal blocks are vertically and horizontally stacked in one or two rows in order to protect from a typhoon and strong wind pressure. The present invention is molded using waste concrete (stone) or waste plastic and comprises: a pair of hexagonal blocks (100a) having a plurality of fixing grooves (110) formed on one surface thereof and facing each other with a predetermined distance therebetween or one hexagonal block (100b); a plurality of connection bars (111) which have both ends thereof fixed to or penetrating the fixing grooves (110) of the pair of hexagonal blocks (100a) and are fixed by means of a fixing pin (180); and a rainwater pack (200) which is positioned between the pair of hexagonal blocks (100a), has a plurality of hooking portions (210, in the shape of a ring or hook) formed in the corners thereof, the hooking portions being coupled to the connection bars (111), and is provided to store rainwater therein.

### BACKGROUND OF THE INVENTION

1. Field of the Invention

This invention relates to an eco-friendly structure, capable of reducing strong wind pressure, and the manufacturing method of this structure. This structure is installed to protect fruit trees and various structures used in farming and fishing communities, temporary buildings, vehicles on a road, and rail and port facilities in the occurrence of typhoon or strong wind pressure. The hexagonal blocks used in the structure are manufactured using industrial waste such as concrete waste (building material) and plastic waste. A plurality of the manufactured hexagonal blocks are vertically and horizontally stacked in one or two rows. This invention relates to an environmental-friendly structure and its manufacturing methods for protecting against typhoon and strong wind pressure and storing rainwater for future use.

2. Description of the Related Art

In general, windbreak walls are constructed to reduce damages in the areas with frequent occurrences of strong wind or gusts. They are largely used on overpasses or bridges, constructed on both left and right sides of freeways or driveways in mountain and seashore areas for protecting vehicles from sudden shakes due to strong wind.

Windbreak walls are constructed with plastic panels or steel and have mainly been used for protecting motor vehicles on such roads. Recently, the windbreak wall usage has extended to fruit farms, in this case, made of mesh to minimize the loss of falling fruits.

However, the windbreak walls constructed with plastic panels or steel on roads or mesh in fruit farms have crucial defects: they are incapable of enduring strong wind pressure or typhoon and are easily destroyed or only partially capable of reducing the damages.

YSC Co. Ltd. proposed the techniques in manufacturing the boards of windbreak walls that improve those addressed defects and acquired the patent in South Korea (Republic of Korea Patent No. 10-0863207). YSC Co. Ltd.'s technique used in windbreak walls mitigates wind strength by installing a plurality of the manufactured windbreak boards separately and have inclination plates at different degrees on upper and lower parts of the boards to induce the flow of wind and mitigate the wind strength. Also, the spindles rotating within certain range on the buffer member are installed to reduce wind strength.

However, this technique of adapting rotatable parts may easily be damaged by strong typhoon or gale pressure. Furthermore, the spaces between windbreak boards may cause those thin boards to break by wind pressure. In addition, this technique requires to construct windbreak walls separately before assembling on a single windbreak buffer member that the production and maintenance costs are inevitably high.

This invention overcomes these shortcomings presented in existing techniques of windwall construction; it reduces damages on various structures and fruit trees due to strong wind in farming and fishing communities, provides a rainwater storage technique on reclaimed land or the areas with deficient water for agricultural use, as well as an indirect effect on noise prevention. This invention has numerous capabilities that facilitate mobility and various usages in addition to the existing function of windbreak walls.

### Technical Objectives

To improve on shortcomings on existing techniques of windbreak wall construction, a plurality of stacked hexagonal blocks are assembled on top or next to each other. This invention is for protecting fruit trees and various structures used in farming and fishing communities, temporary buildings, vehicles on a road, and rail and port facilities in the occurrence of typhoon or strong wind pressure.

By reusing concrete waste (building material) and plastic waste for manufacturing stacked hexagonal blocks, it can reduce the cost of waste disposal in the region. When the hexagonal blocks are in pair, they are assembled vertically and horizontally in two rows and a single block is also arranged horizontally and vertically in one row for the purpose of protecting from typhoons and strong wind pressure. The caps attached on hexagonal blocks become separated from the plastic blocks when there is strong wind pressure in order to reduce direct pressure on the blocks. Between paired hexagonal blocks, the rainwater storage is installed to collect rainwater in a storage tank for any future usage including agricultural usage in reclaimed or water-deficient areas.

Furthermore, this invention can be installed on uneven or weak surfaces.

The above objectives and purposes of this invention are not exhaustive and other unspoken purposes are understandably addressed in the following section.

### Problem-Solving Methodology

Embodiments of this invention use concrete waste (building material) and/or plastic waste for molding. There is a single hexagonal block 100b or a pair of hexagonal blocks 100a, 100b that are located a certain distance apart from but face each other. In an embodiment, each hexagonal block comprises a plurality of fixing grooves 110. There is a plurality of connection bars 111 that go through the plurality of fixing grooves 110 and are fixed or stabilized with fixing pins 180. There is a rainwater storage 200 for rainwater reposition, wherein the rainwater storage 200 is located between a plurality of hexagonal blocks 100a, 100b. The rainwater storage 200 comprises a plurality of ring portions 210 (circular or hook shapes) that connect to the connection bars 111. The plurality of ring portions 210 may be located on the corners of the rainwater storage 200.

Furthermore, in an embodiment, there is a plurality of ventilation holes 120 that penetrate each side of the hexagonal block 100a.

In an embodiment, the pair of hexagonal blocks 100a, 100b uses waste concrete (building material) and comprises mesh network 130 that is attached on both sides, thereby preventing cracks or damages. The pair of hexagonal blocks 100a, 100b each comprises a plurality of ventilation holes 140 that penetrate each side of the hexagonal block. The hexagonal blocks 100a, 100b are stacked next to and on top of each other in rows of one or two.

In addition, in an embodiment, there is a C-shaped supporting block with an open top 160 located under the plurality of hexagonal blocks 100a, 100b. Further, there is a supporting anchor 161 that is attachable to the surface of the supporting block 160. Further, the hexagonal blocks 100a, 100b at the bottom-most layer are supported by the supporting blocks 160. There is a base block 160 located between the supporting blocks 160 and the hexagonal blocks 100a, 100b at the bottom-most layer. The base block 150 has one or more surfaces, wherein the surfaces are narrower at the top. This increases airflow.

Further, in an embodiment, there is a connection pipe 220 that is connected to the rainwater storage 200. The rainwater that is stored in the rainwater storage 200 gets transported via the connection pipe 220. There is a rainwater collector 230 providing greater surface area that is located above the rainwater storage 200. The rainwater collector 230 is flexible and anti-corrosive. Further, there is an Impurity-prevention net 231 located on top of the rainwater collector 230 that prevents impurities from entering the invention. There is a preliminary rainwater pipe 240 located beneath the rainwater collector 230 that is capable of filtering polluted rainwater. Further, there is a level sensor 241 located on the side of the preliminary rainwater pipe 240 that is capable of detecting rainwater. Further, there is a preliminary rainwater discharge pipe 242 that discharges rainwater that is filtered by the preliminary rainwater pipe 240.

In an embodiment, there is a transportation pipe 250 that transports the rainwater stored in the bottom-most rainwater storage 200. Further, there is a storage tank 260 that stores the rainwater transported by the transportation pipe 250 in one place. There is a filter 270 that is located in an inlet portion 261 of the storage tank 260, wherein the filter 270 filters impurities that are present in the transported rainwater.

Further, in an embodiment, the hexagonal blocks 100a, 100b are stacked next to and on top of each other. There are tension bars 141 that are inserted in penetration holes 140 that are present on the hexagonal blocks 100a, 100b. There are strings 170 that are used for stabilizing the hexagonal blocks 100a, 100b. Further, there is a fixation ring 171 that is located on a single side of each hexagonal block 100a or 100b and on both sides of the pair of hexagonal blocks 100a, 100b. The fixation ring 171 located on the surface of each hexagonal block is used for fixing the strings in place. Each hexagonal block 100b comprises the fixation rings 171 in the center of both of its sides so that when the hexagonal blocks do not collapse when stacked on top of one another.

Moreover, in an embodiment, there is an insertable cap 121 that is used for reducing the wind pressure exerted on each hexagonal block 100b when a strong wind is generated by the plurality of ventilation holes 120 formed on each hexagonal block 100b.

In an embodiment, there are several stages in the disclosed structure that reduces wind pressure and provides rainwater storage. There is a sorting stage S10 that sorts concrete waste (building material) and plastic waste. There is a crushing stage S20 that crushes the sorted concrete waste (building material) and plastic waste. The concrete waste (building material) and waste plastic are provided via the crushing stage S20. After the crushing stage, there is a molding frame production stage and a paraffin application stage S30, S30-1 for manufacturing the hexagonal blocks.

Further, in an embodiment, after the molding frame production stage and the paraffin application stage S30, S30-1, there is a main reinforcement and mesh network installation stage S40 for installing the frame on the molding frame, which uses the waste concrete (building material) for manufacturing hexagonal blocks. Further, there is a mixing stage S50 that mixes the crushed waste concrete (building material) and cement (mortar) that would be input into the molding frame. Further, there is an input stage S60 where the mixed material output from the mixing stage S50 is input into the molding frame. Further, there is a demolding stage S70 after the input stage S60.

For plastic waste, there is a mixing stage S40-1 for mixing crushed plastic waste with binder after the molding frame production stage and the paraffin application stage S30-1. This stage is for manufacturing hexagonal blocks with the plastic waste. Furthermore, there is an input stage S50-1 for inputting the mixed material output from the mixing stage S40-1 into the molding frame. Then, there is a demolding stage S60-1 for demolding the molded product after the input stage S50-1. Finally, there is a processing stage S70-1 for processing the molded product output from the demolding stage S60-1.

### BRIEF DESCRIPTION OF THE DRAWINGS

FIG. 1 shows a perspective view of hexagonal blocks relating an eco-friendly structure and the manufacturing method allowing wind pressure reduction and rainwater storage.

FIG. 2 shows a perspective view of combinations of hexagonal blocks, eco-friendly structures capable of wind pressure reduction and rainwater storage, and the manufacturing method.

FIG. 3 shows a cross-sectional diagram of the hexagonal blocks, eco-friendly structures capable of wind pressure reduction and rainwater storage, and the manufacturing method.

FIG. 4 shows a block diagram explains the manufacturing method of the hexagonal blocks, eco-friendly structures capable of wind pressure reduction and rainwater storage.

FIG. 5 shows a deal drawing depicting the hexagonal blocks, eco-friendly structures capable of wind pressure reduction and rainwater storage, and the manufacturing method.

FIG. 6 shows a diagram depicting wind flows on this invention, eco-friendly structures capable of wind pressure reduction and rainwater storage, and the manufacturing method.

FIGS. 7 and 8 are design plans depicting this invention, environment-friendly structures capable of wind pressure reduction and rainwater storage, and the manufacturing method.

### DETAILED DESCRIPTION

This section explains the details descriptions of an embodiment of the invention with reference to the accompanying drawings, briefly explain above. For the purposes of clarity and simplicity, the detailed descriptions of commonly known functions or constructions are not addressed, when it is determined that the descriptions unnecessarily obscure the gist of the invention.

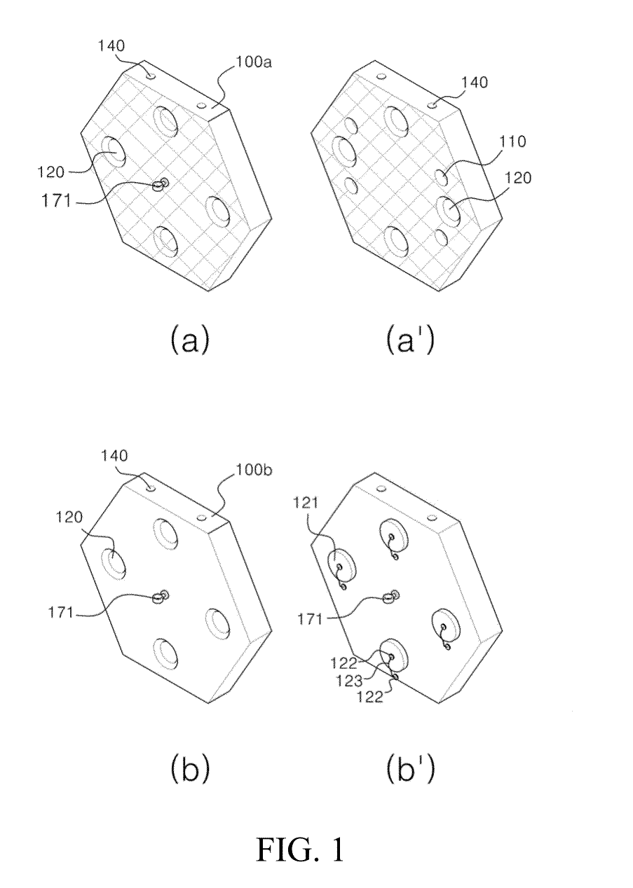

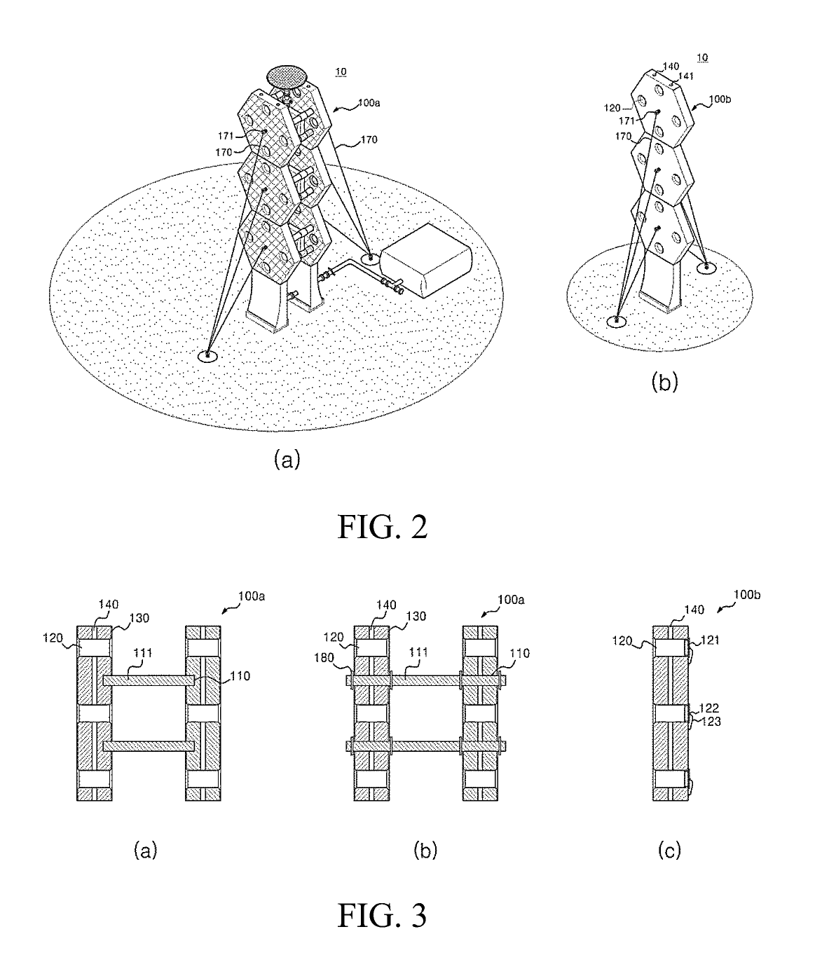

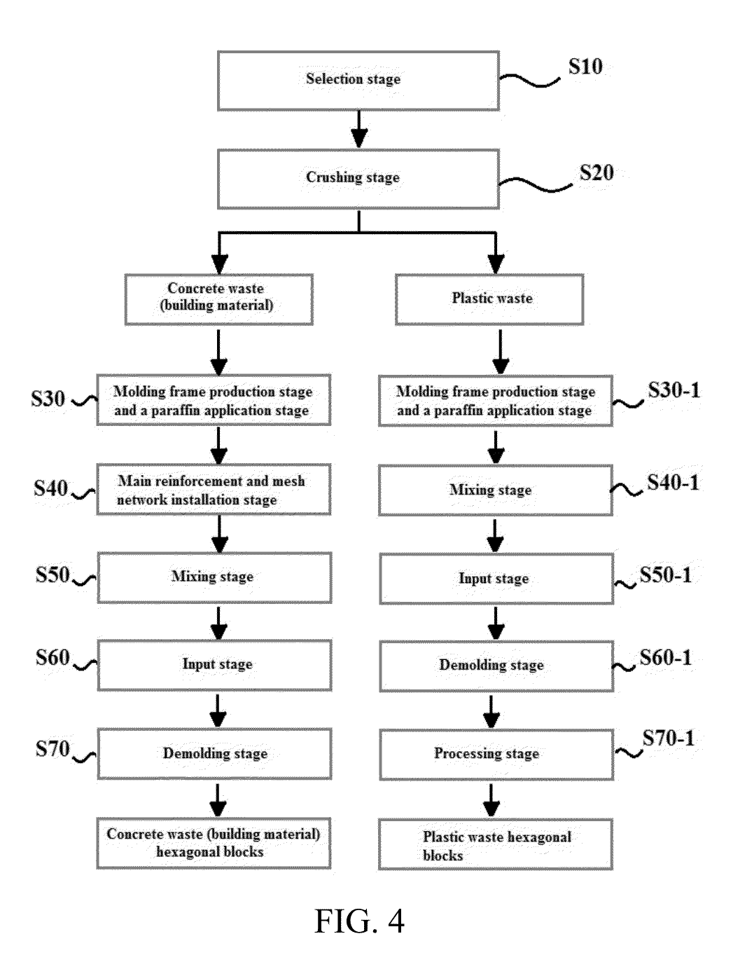

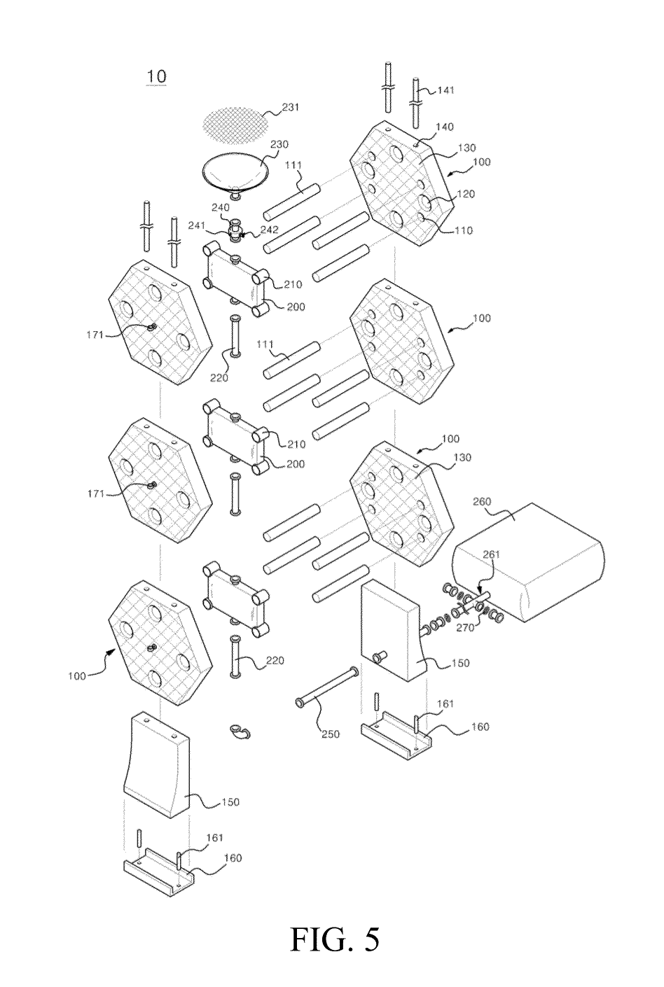

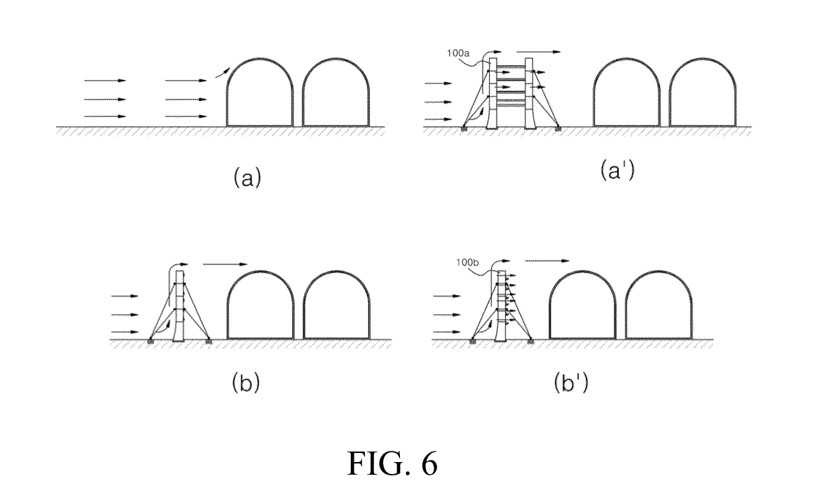

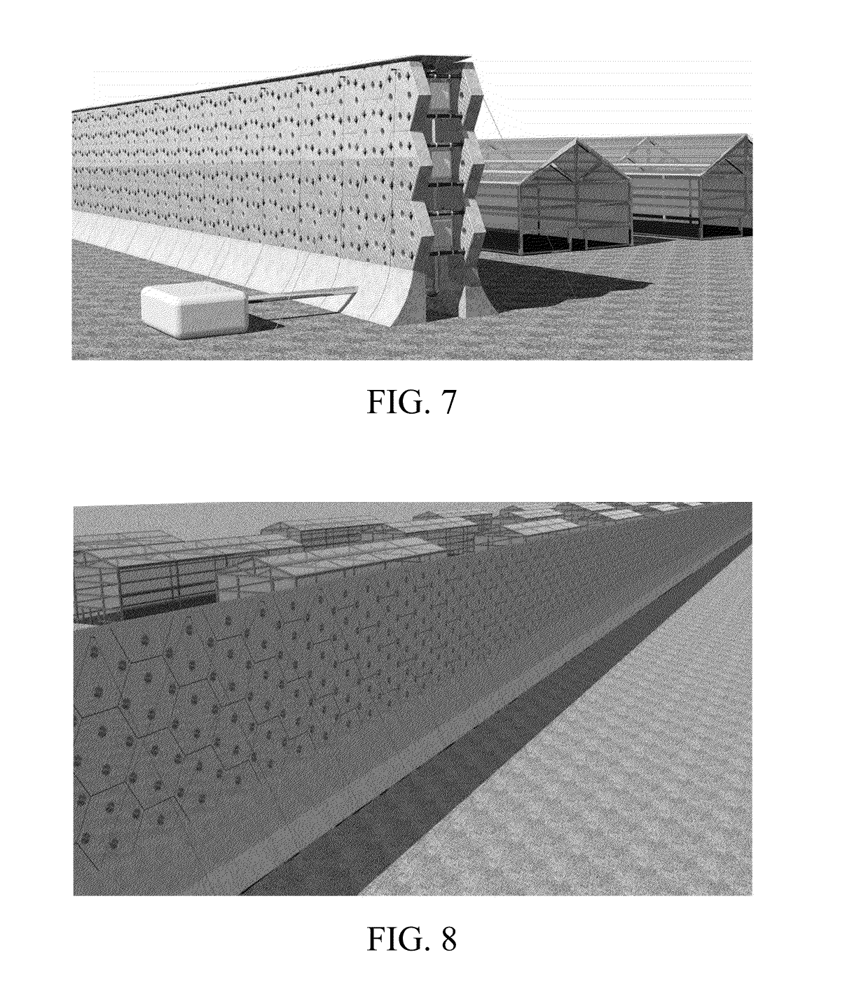

FIG. 1 is a perspective view of this invention's hexagonal blocks; FIG. 2 is a perspective view of an arrangement of the hexagonal blocks illustrated in FIG. 1; FIG. 3 is a sectional view of FIG. 1, the hexagonal block; FIG. 4 is a block diagram depicting a manufacturing method of the hexagonal block in FIG. 1; FIG. 5 is a deal drawing of FIG. 2, an arrangement of hexagonal blocks; FIG. 6 is a diagram depicting wind flows on the invention; and FIGS. 7 and 8 are design plans of the invention in commercial use.

As illustrated in the figures, each hexagonal block comprises a plurality of fixing grooves 110. There is a plurality of connection bars 111 that go through the plurality of fixing grooves 110 and fixed or stabilized with fixing pins 180. There is a rainwater storage 200 capable of storing rainwater, wherein the rainwater storage 200 is located between the plurality of hexagonal blocks 100a, 100b. The rainwater storage 200 comprises a plurality of ring portions 210 (circular or hook shapes) that connect to the connection bars 111. The plurality of ring portions 210 may be located on the corners of the rainwater storage 200.

FIG. 1 is a perspective view of this invention's structure 10; as shown, a and a′ are composed of a pair of the hexagonal blocks 100a and b and b′ are composed of a single hexagonal block 100b.

This invention reuse disposable resources such as waste concrete (building material) and waste plastic to manufacture the structures.

Furthermore, this invention uses the rainwater storages 200, made of an elastic pocket, to preserve rainwater and the connecting bars 111, made of birch trees.

There is a plurality of ventilation holes 120 that penetrate each side of a pair of single hexagonal block 100a. 100b reduce wind pressure on hexagonal blocks 100a, 100b in an occurrence of typhoons or strong wind pressure.

In addition, the mesh network 130 is attached on the both sides of the waste concrete hexagonal blocks 100a, 100b during manufacturing to prevent deterioration of the blocks caused by shock and vibration over time.

These mesh networks 130 are installed particularly to prevent any damages on the hexagonal blocks since it is highly liked as exposed to typhoons and strong wind pressure.

Furthermore, the hexagonal blocks 100a, 100b comprise a plurality of ventilation holes 140 that penetrate each side of the hexagonal block so that any reinforcing steel or lumber can be inserted to provide greater solidness on the invention.

The hexagonal blocks are arranged accordingly to the directions of the ventilation holes 140.

As shown in FIG. 3, a is a pair of hexagonal blocks 100a that are fixed on connecting bars 111 with fixing grooves 110 inserted into the bars. b is a pair of hexagonal blocks 100a fixed on connecting bars 111 with fixing grooves 110 projected externally that the external and internal portions are fixed with fixing pins so that even there is a vibration of a pair of hexagonal blocks 100a, the fixing pins 180 prevent hold the blocks in regular intervals.

Furthermore, c is a cross-section of single hexagonal block 100b that illustrates the method that this invention alerts the operator visually to prevent any further damages by installing an insertable cap 121 on ventilation holes, which disassembles to reduce wind pressure on a single hexagonal block 100b when there is wind pressure on the blocks stronger than usual.

As illustrated in FIG. 2 and FIG. 5, the hexagonal blocks 100a, 100b are stacked next to and on top of each other in rows of one or two.

In a and b, a pair of hexagonal blocks is made of waste concrete (building material) and a single hexagonal block 100b is made of waste plastic and hexagonal blocks can be manufactured in either of waste concrete (building material) or waste plastic depending on preference.

FIG. 2 and FIG. 5 show that the hexagonal blocks 100a, 100b are positioned on a lower side to fix on a surface and the C-shaped supporting block with an open top 160 is attached on the bottom-most layer to support the hexagonal blocks.

There is a supporting anchor 161 that is attachable to the surface of the supporting block 160 to fix on the layer.

Thus, the bottom-most hexagonal blocks 100a, 100b are positioned where the supporting blocks 160 are located.

The base blocks 150 are positioned between the bottom-most hexagonal blocks 100a, 100b and supporting blocks 160 and in order to push the wind flow of typhoons or high wind pressure upwards, either one or both surfaces of the base blocks become narrower to the top, forming a curve shape.

The base block 150 is formed in a curve shape particularly because when it is in angled, the impact of the wind pressure is greater.

Therefore, the base block 150 is positioned at the open parts of the supporting block 160 and the hexagonal blocks 100a, 100b are fixed the upper part of the base blocks 150 by an installer.

In order to assemble in line, there is are ventilation holes 140 on the hexagonal blocks 100a, 100b and the base blocks 150, and the supporting blocks 160 and reinforcing steel or lumber are placed in the ventilation holes 140.

As depicted in FIG. 5, the rainwater storages 200 are linked to each other with connecting pipes 220 and the rainwater preserved in the rainwater storage 200 can be transported from storages located at the top to bottom via the connecting pipes 220.

There are ring portions 210 at the corners of the rainwater storage 200 to join with the connecting bars 111 that are attached to a pair of hexagonal blocks 100a.

The rainwater storage 200 are elastic, preventing the damages that may caused by volume expansion or freezing and bursting during winter period.

Furthermore, the upper part of rainwater storage 200 equips a rainwater collector 230 to extend the area to catch the rainwater. The rainwater collectors 230 are made of non-rusting material and the Impurity-prevention net 231 placed on the upper part of the collectors are made to prevent foreign substances entering the rainwater storage 200.

Even polluted water enters the rainwater collectors 230, the preliminary rainwater pipe 240 is located at the lower part of the rainwater collectors 230 to filter and discharge impurities through the preliminary rainwater discharge pipes 242. The level sensors 241 in the preliminary rainwater pipes 240 measure the level of rainwater and discharge any excessive amount of water above the selected fixed quantity that the preliminary rainwater pipe 240 are designed to hold.

As indicated in FIG. 5, a side of bottom-most rainwater storage 200 is connected to a storage tank 260 located on a side of this invention/structure 10 to accumulate all the collected rainwater in one place via the connecting pipes 250.

The inlet portion 270 of the storage tank 260 uses filter 270 to filter other substances in collected rainwater in transit. Thus, the filter 270 is made to facilitate discharging the foreign substances.

This invention's hexagonal blocks 100a, 100b at the top and bottom are assembled with the tension bars inserted through the penetration holes on the blocks that the united formation has tolerant stability against typhoons and strong wind pressure.

Moreover, the hexagonal blocks 100a, 100b are stabilized with the string 170 attached to the fixation rings 171 on one or both sides of the blocks 100a, 100b.

The fixation rings 171 on the hexagonal blocks firmly hold the strings 170 attached to other fixation rings 171 on the surface such as land to further prevent potential damages from strong wind pressure.

As shown in FIG. 3, there is an insertable cap 121 is place on a side of a plurality of ventilation holes 120 on the single hexagonal block 100b. In the case of strong wind pressure removes the insertable cap 121 from the ventilation holes 120, the lower part of ventilation holes 120 and the middle of the cap façade are fixed with a wire fixing member 122.

Even in the case of the insertable caps 121 become disattched, the structure is designed to hold the insertable caps 121 on the hexagonal blocks (100a, 100b) with the cap wires 123 hanging between the wire fixing members 122.

The above section explains the arrangement condition of a pair of hexagonal blocks 100a and a single hexagonal block 100b and the following section below explains the manufacturing method of the hexagonal blocks 100a, 100b used in the structure.

This invention is a structure that is capable of strong wind pressure reduction and rainwater reposition. In order to select the manufacturing material, concrete waste (building material) and plastic waste, it follows a selection stage S10 and then a crushing stage S20, where concrete waste (building material) and plastic waste are fragmented into certain sizes.

After the crushing stage S20, there is a molding frame production stage and a paraffin application stage S30, S30-1 for manufacturing the hexagonal blocks. In this stage, paraffin is applied on molding frames to facilitate extracting the product from the frames.

Subsequent to the molding frame production stage and the paraffin application stage S30, S30-1, there is a main reinforcement and mesh network installation stage S40 for installing the frame on the molding frame, which uses the concrete waste (building material) for manufacturing hexagonal blocks.

Furthermore, there is a mixing stage S50 that mixes the crushed waste concrete (building material) and cement (mortar) that would be input into the molding frame. After the mixing stage S50, there is an input stage S60 where the mixed material output from the mixing stage S50 is placed into the molding frame.

Lastly, a demolding stage S70 for removing the output from the frames follows after the output solidifies during the input stage S60 to manufacture hexagonal blocks using concrete waste (building material).

The hexagonal blocks made of plastic waste proceed the mixing stage S40-1 for mixing crushed plastic waste with binder after the molding frame production stage and the paraffin application stage S30-1. A demolding stage S60-1 for demolding the molded product follows after the input stage S50-1. Then, in a processing stage S70-1, the molded product output from the demolding stage becomes the hexagonal blocks made of plastic waste.

In sum, the hexagonal blocks 100a, 100b made of concrete waste (building material) and plastic waste are produced after such stages explained above.

The concrete waste (building material) may come from any places including the future installation locations. For instance, in the case of installation on Jeju Island, basalt would be an appropriate input in the hexagonal block manufacturing as it is the most abundant resources in the region in addition to its high mixing rate with cement (mortar) and light-weight.

FIG. 6 illustrates the impact of wind pressure on the structures. Compared the diagram a, a′ depicts that there is almost no wind pressure on properties as a pair of hexagonal blocks 100a is installed. In the diagrams b and b′ delineate that the structure 10 pushes wind upwards at average wind pressure and in an occurrence of high wind pressure, the structure reduces the pressure by displacing the insertable caps 121 to partially allow wind passing the structure.

FIG. 7 is a three-dimensional 3D plan of the structure 10 composed of a pair of hexagonal blocks 100a that was used in an actual experiment on strong wind pressure and FIG. 8 is a 3D-plan of a structure of a single hexagonal block 100b that holds similar conditions to an actual installation.

Hereby, this specification and figures adhere to providing appropriate implementation embodiments and the usages of particular language are not to place limitations on the invention, but to facilitate understanding of the details on techniques relating to this invention as in general definitions. In addition to the embodiments disclosed here, applied embodiments described above are developed by an intellectual in the field based on technical concepts.

### REFERENCE NUMERALS

10 Structure of the invention
100a Pair of hexagonal blocks
100b Single hexagonal block
110 Fixing groove
111 Connecting bar
120 Ventilation holes
121 Insertable cap
122 Wire fixing member
123 Cap wire
130 Mesh network
140 Penetration holes
141 Tension bar
150 Base block
160 Supporting block
161 Supporting anchor
170 String
171 Fixation ring
180 Fixing pins
200 Rainwater storage
210 Ring portion
220 Connecting pipe
230 Rainwater collector
231 Impurity-prevention net
240 Preliminary rainwater pipe
241 Level sensor
242 Preliminary rainwater discharge pipe
250 Transporting pipe
260 Storage tank
261 Inlet portion
270 Filter

### INDUSTRIAL APPLICABILITY

This invention have following effects: First, a plurality of hexagonal blocks are stacked on top and side of each other protect various structures and fruit trees in farming and fishing communities, temporary construction structures and temporary buildings, vehicles on a road, and rail and port facilities in an occurrence of typhoon or strong wind pressure.

Second, the manufacturing process of the hexagonal blocks reduces waste disposal cost by using concrete waste (building material), plastic waste, and any other waste resources as the composition of the blocks.

Thirds, there are installation options to accommodate the need of sites; a pair of hexagonal blocks can be stacked next to and on top of each other in rows of two and a single hexagonal block in one row.

Fourth, a cap on a single hexagonal block insulates the direct wind pressure that it prevents damages and extend the lifespans of hexagonal blocks.

Fifth, a rainwater storage is located between a pair of hexagonal blocks to collect rain and store in the storage tank that the rainwater can be used as agricultural usages in water deficient areas.

Sixth, supporting blocks allow installing windbreak walls on uneven or weak surfaces.

What is claimed is:

1. An environment-friendly structure molded with concrete waste or plastic waste for reducing wind pressure and storing rain water, the structure comprising:
a hexagonal block (100b) or a pair of hexagonal blocks (100a, 100b) that are placed a certain distance from each other, wherein each of the hexagonal blocks comprises a plurality of fixing grooves (110);
a plurality of connection bars (111) that connect to the plurality of fixing grooves (110), wherein the plurality of connection bars (111) are fastened with fixing pins (180); and
a rainwater storage (200) located between the pair of hexagonal blocks,
wherein the rainwater storage (200) comprises a plurality of ring portions (210) that connect to the plurality of connection bars (111).

2. The environment-friendly structure of claim 1, wherein the pair of hexagonal blocks comprises a plurality of ventilation holes (120).

3. The environment-friendly structure of claim 1, wherein if produced with concrete waste, the hexagonal blocks comprise waste mesh network (130) for preventing cracks or damages.

4. The environment-friendly structure of claim 1, wherein the hexagonal blocks comprise a plurality of penetration holes (140)

5. The environment-friendly structure of claim 1, wherein the hexagonal blocks are stacked on top of each other in one or more rows.

6. The environment-friendly structure of claim 1, wherein the environment friendly structure further comprises a C-shaped supporting block (160) located below the hexagonal blocks, wherein the C-shaped supporting block has an open top surface, wherein the bottom-most hexagonal blocks are located within a space formed by the supporting blocks (160).

7. The environment-friendly structure of claim 6, wherein the environment-friendly structure further comprises the base blocks (150) located between the supporting blocks and the bottom-most hexagonal blocks (100a, 100b), wherein the base blocks (150) are stacked in a curve-shape and the width of a side or both sides of the base blocks (150) narrows as ascending.

8. The environment-friendly structure of claim 1, wherein the environment-friendly structure further comprises the connecting pipes (220) that connect the rainwater storages (200); wherein the stored rainwater in the rainwater storages (200) is transferred from the upper to lower part via the connecting pipes (220).

9. The environment-friendly structure of claim 1, wherein the environment-friendly structure further comprises the rainwater collectors (230) in the upper part of the rainwater storage (200) that extend the rainwater collecting areas; wherein the rainwater collectors (230) is manufactured with non-rusting material and acquires elasticity; wherein the rainwater collectors (230) comprise the impurity-prevention net (231) that prevent foreign substances entering into the structure.

10. The environment-friendly structure of claim 9, wherein the rainwater collectors (230) further comprise the preliminary rainwater pipes (240) that filters the polluted preliminary rainwater to a lower location;
wherein the preliminary rainwater pipes (240) comprise the level sensor (241) placed on a side that detects the preliminary rainwater entering the pipes and the preliminary rainwater discharge pipes (242) that discharge the undesirable water.

11. The environment-friendly structure of claim 1, wherein the bottom-most rainwater storages (200) further comprise the transporting pipes (250) that transfer the stored water to different locations, wherein an environment-friendly structure further comprises the storage tank (260) where all the collected water in the rainwater storages (200) is aggregated via the transporting pipes (250).

12. The environment-friendly structure of claim 11, wherein the environment-friendly structure further comprises the filters (270) on the inlet portions (261) of the storage tank (260) that filter foreign substances from the collected water in transit.

13. The environment-friendly structure of claim 4, wherein the environment-friendly structure further comprises the tension bars (141) inserted to the penetration holes (140) that penetrate a plurality of the hexagonal blocks (100a, 100b) stacked next to each other.

14. The environment-friendly structure of claim 1, wherein the environment-friendly structure further comprises the strings (170) that stabilize the hexagonal blocks (100a, 100b); the fixing rings (171) that are attached on a selected location and one-side of a pair of the hexagonal blocks (100a) or both sides of a single hexagonal block (100b)

15. The environment-friendly structure of claim 1, that uses the method to fix the structure against strong wind pressure by assembling single hexagonal blocks (100b) stacked on top or next to each other with the fixing rings (171) placed in the center of both sides of single hexagonal blocks. (100b)

16. The environment-friendly structure of claim 1, wherein the environment-friendly structure further comprises the insertable caps (121) placed on a plurality of ventilation holes (120) on single hexagonal blocks (100b) for reducing the pressure of strong wind; the wire fixing members for preventing damages in a case of the insertable caps (121) are displaced from the ventilation holes on single hexagonal blocks (100b).

17. An environment-friendly structure (10) manufacturing method, capable of wind pressure reduction and rainwater reposition, the method comprising:
a selection stage (S10) to select appropriate concrete waste (building material) and plastic waste;
a crushing stage (S20) to crush the selected concrete waste (building material) and plastic waste; and
a molding frame production stage and a paraffin application stage (S30, S30-1) for manufacturing hexagonal blocks after preparing the selected concrete waste (building material) and plastic waste to reuse for manufacturing the hexagonal blocks via the crushing stage (S20).

18. The environment-friendly structure manufacturing method of claim 17, wherein, in order to manufacture hexagonal blocks utilizing the concrete waste, the structure manufacturing method further comprises:
a main reinforcement and mesh network installation stage (S40) for installing the frame on the molding frame;
a mixing stage (S50) for mixing the crushed concrete waste (building material) and cement (mortar) that would be input into the molding frame;
an input stage (S60) for placing the mixed output from the mixing stage (S50) into the molding frame; and
a demolding stage (S70) for removing the solidified mixing from the molding frames used during the input stage (S60).

19. The environment-friendly structure manufacturing method of claim 17, wherein, in order to manufacture hexagonal blocks utilizing the plastic waste, the structure manufacturing method further comprises:
a mixing stage (S40-1) for mixing the crushed plastic waste with binder;
an input stage (S50-1) for inputting the mixed material output from the mixing stage (S40-1) into the molding frame;
a demolding stage (S60-1) for demolding the molded product follows after the input stage (S50-1); and
a processing stage (S70-1) for commercializing the molded output from the demolding stage (S60-1).
